(19) United States
(12) Patent Application Publication
(10) Pub. No.: US 2007/0007021 A1
(43) Pub. Date: Jan. 11, 2007

(54) FIRE RETARDENT SMART BOMBS

(76) Inventor: Colin Regan, Wabamum (CA)

Correspondence Address: Paul A. Taylor, PO Box 24103, Seattle, WA, 98124-0103, US

(21) Appl. No.: 11/160,814

(22) Filed: Jul. 11, 2005

(51) Int. Cl. A62C 13/22

(52) U.S. Cl. 169/84; 102/489; 102/211

(57) ABSTRACT

The present invention relates to ordnance which is dropped by an aircraft over a forest fire to snuff out the available oxygen fuel supply to the fire. More specifically, the invention relates to ordnance which is comprised of a dispenser, missile or rocket containing a plurality of submunitions. Each submunition is actuated to detonate over the target zone at a preset elevation via altimeter actuators on the fuze and each dispenser is triggered to dispense the payload of submunitions based on the geographical positioning of the ordnance.

### BACKGROUND OF THE INVENTION

The present invention relates to ordnance which is dropped by an aircraft over a forest first. The ordnance is comprised of a plurality of individual submunitions; each submunition is designed to detonate at a preset altitude and geographical position over the forest first. The detonation of each submunition acts to snuff out the available oxygen supply to the fire and disperse a volume of fire retardant over the target-zone.

The term “smart bomb” will be used to define a specific type of ordnance which may be equipped with a special inertial guidance system such as a laser, radar, or Global Positioning System (GPS). The inertial guidance system allows the ordnance to select the precise latitudinal and longitudinal coordinates over the target zone The ordnance is comprised of a plurality of submunitions, each of which is comprised of an altimeter actuated fuse which is triggered to detonate based on the elevation of the submunition above ground zero.

The term “retardant” is defined under a broad construction to include a family of chemicals which are used as effective agents in extinguishing a fire. Preferably, the fire retardant is also biodegradable. The United States Department of Agriculture (USDA) Forest Service uses a thermo gel or other polymers that are water enhancers for Class A fires. For example, a product sold under the commercial product name of Mirex is a common product used by the USDA. Mirex is biodegradable which makes it appropriate for a forest fire application. However, the methods and apparatus of the present invention contemplate the use of any fire retardants that may be used as effective fire extinguishing agents for extinguishing a forest fire.

The term “target zone” is defined as the geographical region of the burning forest which is targeted to be extinguished by the ordnance. As mentioned, the ordnance acts to spread a blanket of fire retardant over this target zone upon detonation of the submunitions at a pre-set elevation above the drop-zone.

The term “ground zero” is defined as a reference point relative to the altitude of the submunition. The term “ground zero” will be defined as having a zero elevation relative to the ground level. Typically, the ground zero will change frequently as an aircraft is flown over hilly terrain. The term “altitude” of the submunition is defined as the elevation of the submunition relative to ground zero. The altitude is a key parameter for the detonation of the submunition which is controlled by the fuze of the detonator of the present invention.

Dropping fire retardant from relatively low altitudes by flying aircraft close to the earth, which may be typically less than a few hundred feet, is an extremely dangerous activity. During a forest fire, the aircraft is vulnerable to terrain, strong thermal updrafts and turbulence, and aerodynamic stresses due to diving and climbing. As a result, many aircraft have disintegrated and crashed under these conditions. Clearly, what is required in the Art is a smart bomb which may be released from a safe altitude above a fire zone that is capable of achieving the desired denotation altitude and predetermined spatial positioning above the forest fire.

Prior Art:

The Boeing Company developed the JDAM (Joint Directed Attack Munition) as a relatively low cost, retrofittable guidance mechanism for a bomb. The JDAM's primary advantage over previous methods is the fact that it can be dropped from up to 45,000 feet with little loss of accuracy, even in difficult weather conditions, so the risk to planes and pilots is minimal. The JDAM maybe modified to deliver a quantity of fire retardant.

Delivery Method of Fire Retardant:

The JDAM usually uses an “airburst” method over the target. The airburst creates a random, unpredictable dispersal of retardant over the target. The primary disadvantage of this method is the dispersal of retardant is relatively non-uniform and unpredictable.

Expired U.S. Pat. No. 3,951,068 issued Apr. 20th, 1976 and assigned to the Dow Corning Corporation discloses an incendiary device such as artillery round, rocket warhead, bomb, or grenade in which a high explosive charge within a casing has imbedded therein a plurality of balls of incendiary material. The incendiary material is a mixture of silicone rubber, powdered magnesium, and an oxidizing agent. The balls are ignited by detonation of the high explosive and are designed to continue burning during dispersion caused by the detonation.

The '068 patent discloses the use of a plurality of smaller submunitions or “balls” for delivering a volume of fire retardant to the fire zone. However, the '068 patent is distinguishable from the methods and apparatus of the present invention because the detonation of the balls occurs as a group or cluster and as a result of detonation of the incendiary device, a random and unpredictable distribution of fire retardant occurs over the target zone.

It is respectfully submitted that the methods and apparatus of the '068 patent do not provide the necessary dispersion and control techniques desired for modern day fire fighting. The methods and apparatus of the present invention provide a means for controlling both the volume of fire retardant to the target zone and the location of the fire retardant over the target zone by providing a plurality of submunitions, each of which contains an individual detonation device. The detonation device for each individual submunition may be pre-set to detonate at the same or a different elevation than the sister submunitions of the cluster.

The methods and apparatus of the present invention provide many advantages over the prior art by providing a means for delivering and detonating each individual submunition at the precise elevation and geographical position. As will be apparent to one skilled in the Art, the methods and apparatus of the present invention provide many degrees of freedom of accuracy over prior art methods by delivering and controlling the dispersal of fire retardant over a fire-zone.

### SUMMARY OF THE INVENTION

In accordance with the present invention, an ordnance is disclosed for extinguishing a forest fire which is comprised of a dispenser for carrying and delivering a plurality of submunitions to a exit position on the dispenser, a door way on the dispenser for providing an exit position for dispersal of a plurality of submunitions from the dispenser, and a plurality of submunitions, each submunition carrying a detonation device, and a volume of retardant; wherein the detonation device in response to a signal from a sensor on the submunition triggers the explosive to detonate the submunition thereby dispersing a volume of fire retardant over the target zone.

In accordance with another aspect of the present invention, a method is disclosed for extinguishing a forest fire which is comprised of the steps of carrying and delivering a plurality of submunitions to an exit position on a dispenser, dispensing a plurality of submunitions from the exit position on the dispenser, each submunition carrying a detonation device, and a volume of retardant; wherein the detonation device in response to a signal from a sensor on the submunition triggers the explosive to detonate the submunition thereby dispersing a volume of fire retardant over the target zone.

In accordance with yet another aspect of the present invention, a specialized submunition is disclosed for extinguishing a forest fire. A plurality of submunitions may be carried and delivered to the target zone by a dispenser, a missile, a rocket, or a projectile and detonated over the target zone by a detonation device which is triggered to detonate by a sensor on each submunition. Detonation of each submunition by the detonation device disperses a volume of fire retardant over the target zone.

### BRIEF DESCRIPTION OF THE DRAWINGS

FIG. 1 shows a cross-sectional view of the dispenser 10 for the smart bomb assembly 1;

FIG. 2 shows a cross-sectional view of a submunition illustrating the detonator and the retardant portions of the submunition;

FIG. 3 shows the internal components of the detonator comprising the sensor, the arming device and the thyractron;

FIG. 4a shows an outer view of the submunition 10 with a quadrant of the submunition removed to show the inner housing 15;

FIG. 4b shows an outer view of the submuntion 10 illustrating the outer housing of the submunition;

FIG. 5 shows the general embodiment of the dispenser 10, according to a general aspect of the present invention;

FIGS. 6a-6c illustrates several embodiments of the dropped dispenser, according to a first preferred embodiment of the present invention;

FIGS. 7a-7c illustrates several embodiments of the attached dispenser, according to a second preferred embodiment of the present invention;

FIG. 8 shows a Cartesian co-ordinate system for illustrating the inertial guidance system of the present invention.

### DETAILED DESCRIPTION

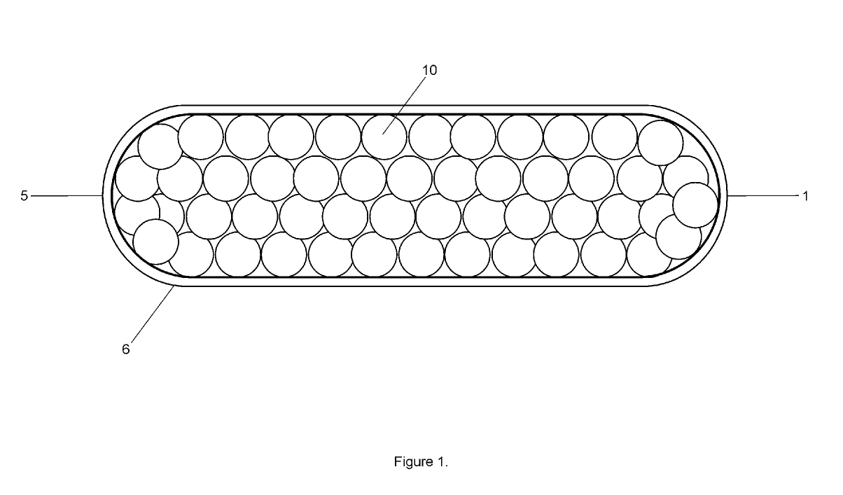

Referring to FIG. 1, a smart bomb assembly 1 is shown. The smart bomb assembly 1 is comprised of a dispenser 5 which contains a plurality of submunitions 10.

In accordance with the present invention, a submunition 10 is shown. Typically, each submunition 10 is spherical in geometry since each dispenser is comprised of any number of submunitions and the nature of this geometry allows a payload of submunitions to be efficiently packed into the dispenser which is typically rectangular in cross-section.

Alternatively, the dispenser 5 and the submunitions 10 may be one unit. For this case, the dispenser 5 is detonated with the submunition. In the preferred embodiment, the dispenser 5 may release the payload of submunitions 10 and remain attached to the aircraft. Alternatively, the dispenser may be released from the aircraft with the payload of submunitions, and the dispenser may release the payload of submunitions and be retrieved post-detonation of the submunitions.

The preferred embodiment of the present invention reduces the overall capital cost of fire management for a given fire zone and will be described herein.

Submunitions:

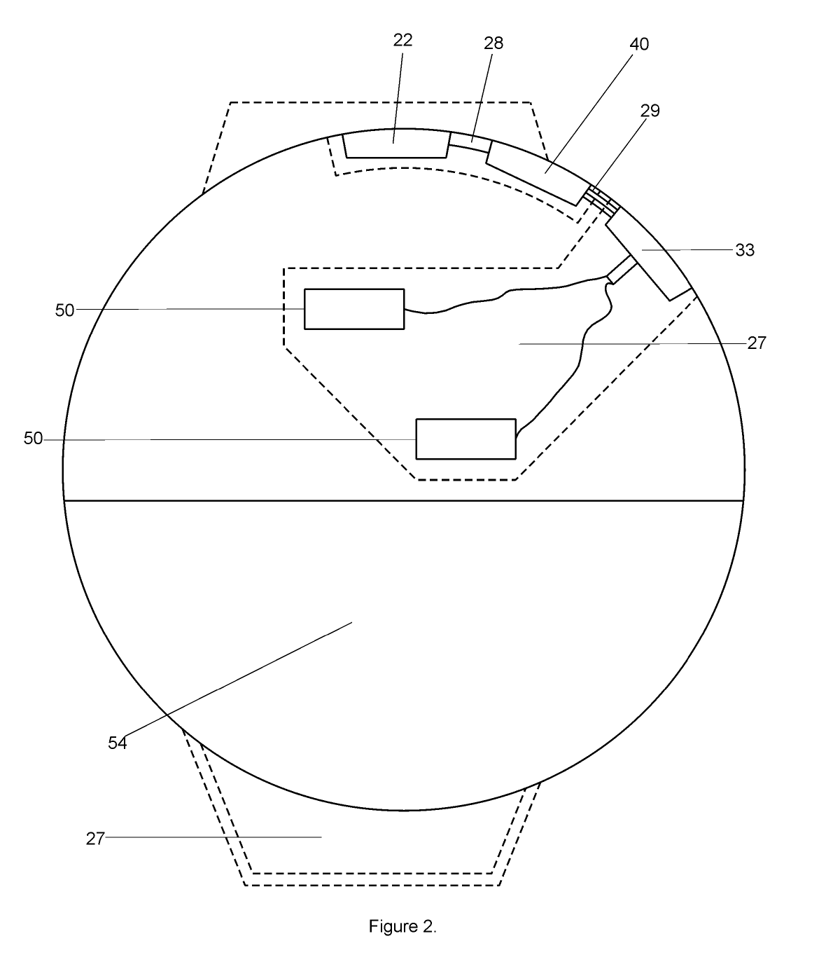

Referring to FIG. 2, each submunition 10 is comprised of a first containment portion 13 that carries the detonation device 24 which is typically a fuse 25. The fuse 25 triggers an explosive 50 to detonate based on an output signal, which is typically an electronic charge, sent from the fuse 25. Typically, the explosive 50 is contiguous with the detonation device 28 and is carried within the submunition by a second containment portion 14.

Each submunition is further comprised of a third containment portion 15 which carries a volume of retardant 54 for dispersal over the fire zone during detonation. The spatial positioning of the falling submunition is coordinated by use of a fin assembly 26. The fin assembly 26 assists the submunition to fall in such a fashion that the third containment portion 15 falls closest to earth as the submunition is dropped through the atmosphere. In this way, detonation of the explosive by the detonation device 28 results in a fragmentation of the outer wall 56 thereby dispersing a volume of fire retardant 54 over the target zone.

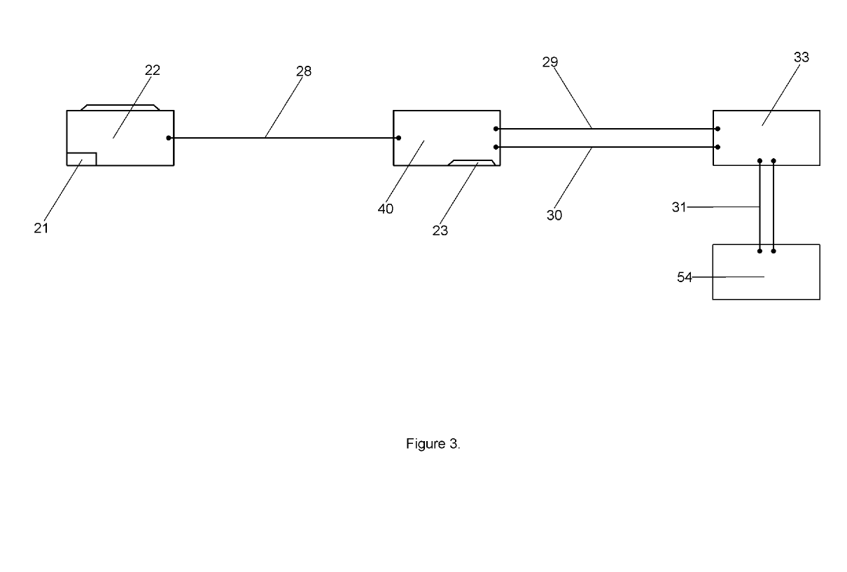

Referring to FIG. 3, each submunition 10 is further comprised of a sensor 22 for determining the precise spatial positioning for detonation of each submunition 10. Typically, the sensor 22 is an optical Doppler or photoelectric sensor.

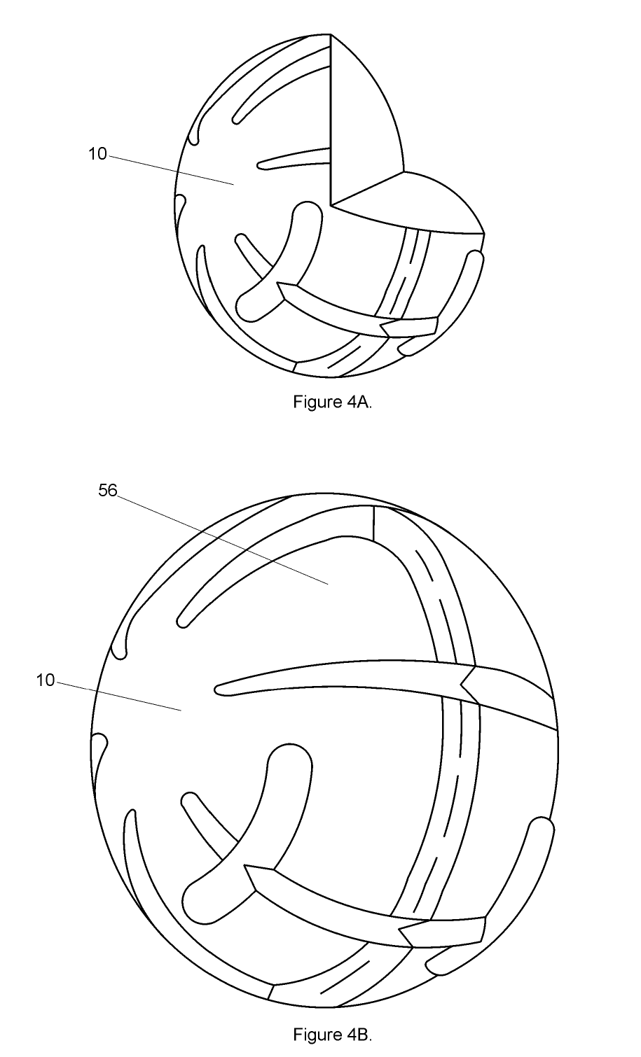

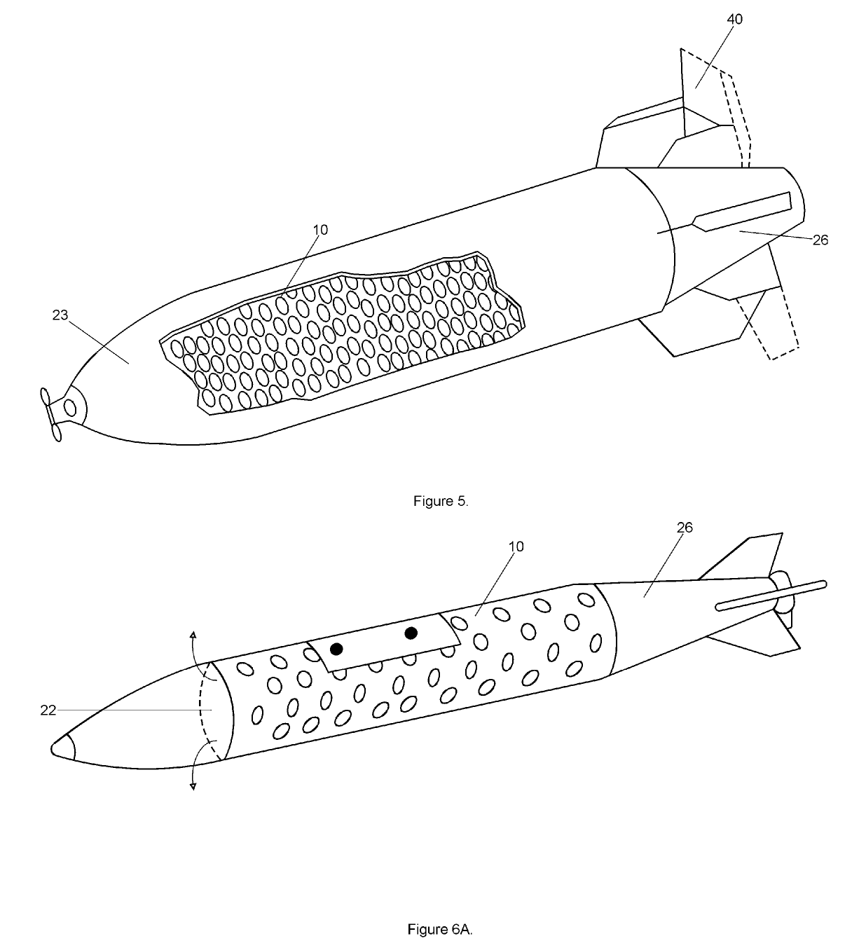

FIG. 4 illustrates the outer wall 15 of the submunition 10. Each submunition may be either a bomblet, grenade, or mine variety. Preferably, each submunition is a small explosive-filled and or chemical-filled item designed for saturation of a large surface area upon detonation. The scope of the invention contemplates that each submunition may be antipersonnel (APERS), anti-materiel (AMAT), antitank (AT), dual-purpose (DP), incendiary, or chemical.

The scope of the invention contemplates that the submunitions may be spread by dispensers (as described herein), missles, rockets, or projectiles. Each of these delivery systems dispersers its payload of submunitions while still in flight, and the submunitions drop over the target.

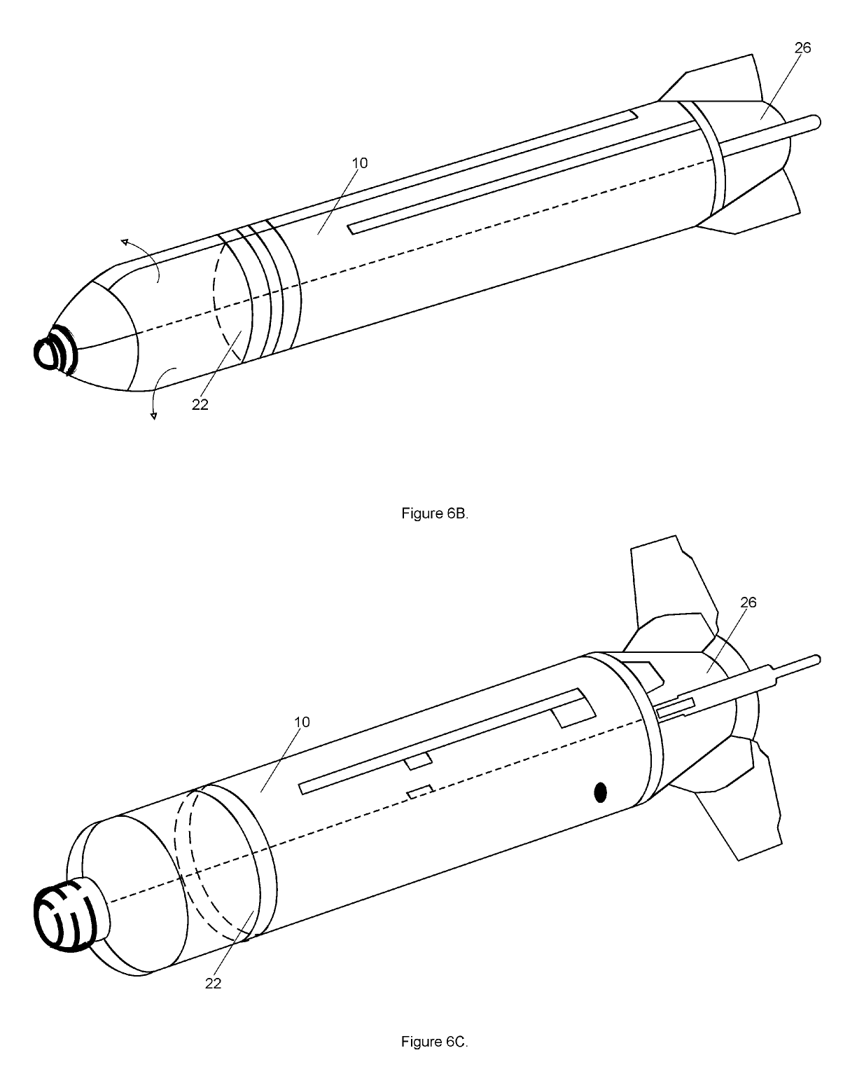

Referring to FIGS. 5-7, the configurations of the dispenser 5 will be described herein:

Dispensers:

Referring to FIG. 5, the dispenser 20, in a general aspect, is comprised of a containment portion 13 for holding a plurality of smaller submunitions 10. The dispenser 20 is further comprised of a payload doorway 22 from which the submunitions 10 are released from the container vessel 21.

The doorway 22 maybe located anywhere on the vessel 21. Preferably, the doorway 22 is triggered to be opened by a proximity fusing subsequent to release of the dispenser 10 from the aircraft. The fusing allows the payload to be dispersed at a predetermined height above the target. Proximity fusing is actuated by detecting an acceleration force as the missle approaches towards the earth. Arming of the fuze is usually delayed until the fuze is subjected to a given level of accelerating force for a specified amount of time.

The location of the doorway 22 may be located anywhere on the sidewall 23 of the vessel 21. Preferably, the location of the doorway 22 will be selected to optimize the preferred distribution of the payload of submunitions 10 above the target.

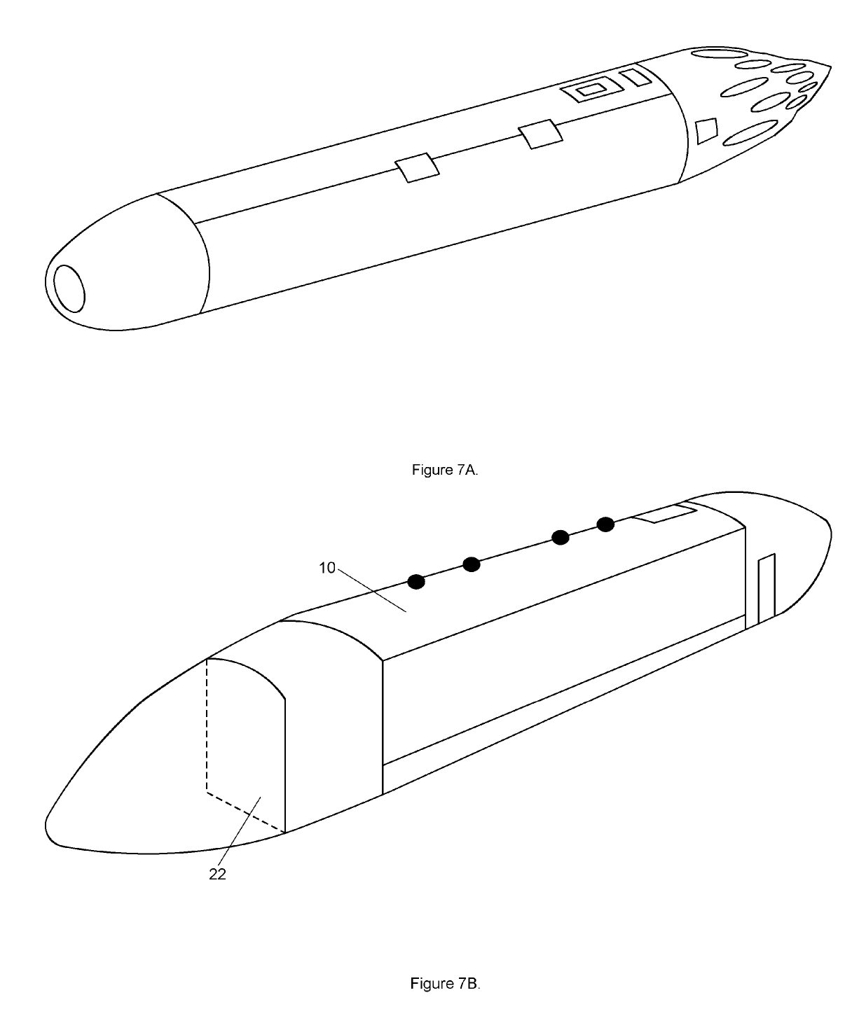

In a first embodiment, the dispenser is a dropped dispenser 20 (see FIGS. 6a-6c). The dropped dispenser is designed to fall away from the aircraft and is stabilized in flight by a fin assembly 26.

The invention contemplates that the dropped dispensers may be in one piece or in multiple pieces. The dropped dispensers may use either mechanical time or proximity fusing. Both of these fuses allow the payload to be dispersed at a predetermined height above the target. Multiple-piece dispensers open up and disperse their payload when the fuse is actuated. Single-piece dispensers eject their payload out of ports or holes in the body when the fuse is actuated.

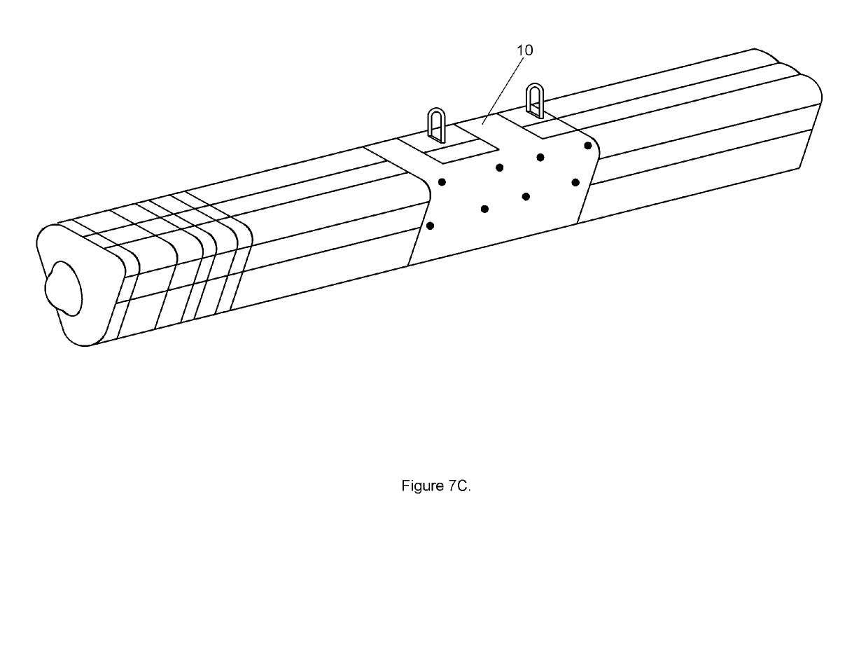

In a second embodiment, the dispenser is an attached dispenser 30 (see FIGS. 7a-7b). Attached dispensers stay attached to the aircraft and can be reloaded and used again. The payload is dispersed out the rear or from the bottom of the dispenser.

It will be apparent to one skilled in the Art, that the invention contemplates any type of dispenser—attached, dropped, or otherwise. What is important is the ability to carry a plurality of submunitions to a target zone and dispense the payload in a uniform and efficient manner.

Fuse Assembly:

Each submunition 10 is detonated by the action of the fuze 25. The fuse 25 triggers the detonation of an explosive charge 27 at the precise time after certain key parameters are met.

The invention contemplates that the fuze 25 may be a proximity fuze or a contact fuze.

A proximity fuse is intended to detonate each submunition upon approach to the target zone and more specifically, typically along the flight path of the submunition. The scope of the invention contemplates various methods of obtaining a proximity operation against a target zone: electrostatic, acoustic, optical, and radio fuses.

A contact fuze is intended to detonate each submunition based on the force of impact with ground zero. The force of impact closes a firing switch (not shown) within the fuze to complete the firing circuit thereby detonating the warhead.

The acceleration forces which result upon launching the missle from the aircraft arm both types of fuzes.

In accordance with a preferred aspect of the present invention, the fuze 25 is an optical or photoelectric type. The photoelectric method provides a relatively easy approach to providing proximity fuzing. Typically, the photoelectric method is limited to daytime use, unless light sources are available. However, the term “fuze” should be construed under a broad construction to contemplate any type of fuzing which function with the Safety & Arm (S&A) device, and Thyractron to detonate the submuntion.

Optical Doppler-Type Fuze:

Referring to FIG. 11, an optical Doppler fuze 25 is shown. The actuating signal is produced by a wave reflected from the target zone moving with respect to the fuze. The frequency of the reflected wave (RW) differs from that of the transmitted wave (TW), because of the relative velocity of the fuze and the target zone.

The interference created between both waves results in a low-frequency input signal 28 which is transferred to a transmitter (not shown). The input signal is used to trigger an electronic switch, which is typically a trigger device on the detonator. Typically, the input signal 28 requires amplification by an amplifier 44. The amplifier 44 creates an output signal 29 which is used to actuate the trigger device 33.

Trigger Device:

Operation of the fuze 22 occurs when the output signal 29 is received from the amplifier. The output signal 29 is received by the trigger device 33. The amplitude of the output signal 29 must exceed a required threshold voltage (TV) to fire the trigger device 33. Preferably, the trigger device 33 contemplated by the invention is commercially available under the brand name Thyractron.

Operation of the Trigger Device:

For a given orientation of the fuze and target, the amplitude of the output signal 29 produced by the amplifier (not shown) is a function of the distance (d) between the target and the fuze. Hence, by the use of proper settings for the gain of the amplifier and the holding bias of the Thyratron, the distance (d) of the operation may be controlled.

It will be apparent to one skilled in the art that the distance (d) that the fuze detonates from the ground may not be the only parameter which may be controlled by the fuzing device. Orientation or the aspect (θ) of the submunition is another aspect that may be controlled since operation should occur at that point on the trajectory of the submunition when the greatest number of fragments will be directed towards the target zone.

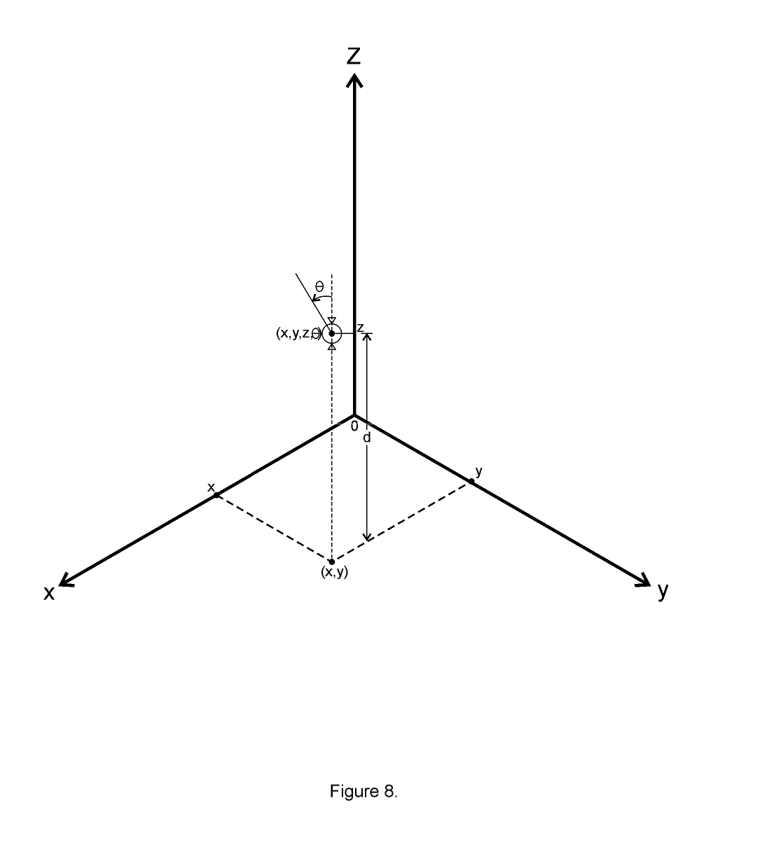

Referring to FIG. 8, a Cartesian coordinate system is shown. The Cartesian coordinate system is comprised of a z-axis, x-axis, y-axis and an origin (o). The z-axis defines the altitude (z) for the bomb. The y-axis defines the longitude (y) for the bomb. The x-axis (x) defines the latitude for the bomb. The aspect (θ) of the submunition is defined at the angle defined between the z-axis and the x-y plane. The combination of the x, y, z, and θ parameters define the spatial positioning (x, y, z, θ) of the submunition relative to the origin.

For example, in the case of the smart bomb assembly, the detonation of the fuse may be triggered by any, all or a combination of these spatial parameters: (x, y, z, θ) of the dispenser or submunition relative to the origin—surface of the earth. Preferably, the aspect (θ) and altitude (z) of the submunition may be used as detonation parameter for controlling the triggering of the fuze.

Referring to FIG. 10, the submunition is further comprised of a fin 40. The fin 40 acts to maintain and stabilize the aspect (θ) of the submunition. Typically, the aspect should be maintained so that the vertical axis of the submunition is held near to vertical such that detonation occurs at that point on the trajectory when the greatest number of fragments is directed towards the target zone.

In a preferred aspect of the present invention, the fuze 25 is further comprised of a Safing and Arming (S&A) device 40. The S&A device 40 is a component of the fuze 25 that isolates the detonation device from the explosive 50 during all phases of the submunition logistic and operational chain until the submunition has been released or launched from the dispenser.

To maximize the safety and reliability of the fuze, the S&A device must ensure that the forces it senses will be unique to the submunition, and cannot be intentionally or accidentally duplicated during ground handling or prelaunch operation. Typically, the S&A device are located between the sensor and the triggering device. The S&A device receive the arming signal 29 from the sensor 22 and determine whether key parameters have been met. Once an arming signal 29 has been sent by the S&A device 40 to the Thyractron 33, a detonation signal 31 is sent by the Thyractron to the explosive 54 triggering the explosive to detonate.

The Explosive

Referring to FIG. 10, the submunition is further comprised of an explosive 50. Firing of the Thyractron 33 triggers the detonation of the explosive 50. The detonation of the explosive 50 results in a subsequent rupturing and explosion of the outer wall 15 of the submunition 10 resulting in a dispersion of the fire retardant 54. The fire retardant 54 is contained in the third containment portion 15 adjacent to the explosive 50.

Preferably, the outer wall 56 of the third containment portion 15 is stabilized towards the target zone such that upon detonation of the submunition, the retardant 54 and bomb fragments explode orthogonally to the surface of the earth thereby maximizing the dispersion of retardant and bomb fragments over the target zone.

What is claimed is:

1. An ordnance for extinguishing a forest fire which is comprised of:
a dispenser for carrying and delivering a plurality of submunitions to an exit position comprising a door way on the dispenser for providing an exit position for dispersal of a plurality of submunitions from the dispenser;
a plurality of submunitions, each submunition carrying a detonation device, a sensor which determines the exact spatial positioning of each submunition relative to a reference position, an explosive which is triggered by a detonation signal received from the sensor, and a volume of fire retardant;
wherein the sensor communicates with the detonation device, the sensor sending a signal to the detonation device to detonate the explosive based on key detonation parameters being satisfied by the sensor thereby dispersing a volume of fire retardant over the target zone.

2. The ordnance, as claimed in claim 1, wherein the dispenser is comprised of an actuation device which triggers the doorway on the dispenser to open and release the payload of submunitions from the dispenser.

3. The actuation device, as claimed in claim 2, wherein the actuation device is triggered to open based on spatial position data received by a geographical positioning system (GPS) located on the dispenser.

4. The detonation device, as claimed in claims 2 or 3, wherein the detonation device is further comprised of a Safe and Arming (S&A) device.

5. The ordnance, as claimed in claims 3 or 4, wherein the dispenser is a dropped dispenser.

6. The ordnance, as claimed in claim 3 or 4, wherein the dispenser is an attached dispenser.

7. The ordnance, as claimed in claims 5 or 6, wherein the doorway of the dispenser is comprised of a plurality of perforations, each perforation is capable of dispensing several submunitions.

8. The ordnance, as claimed in claims 5 or 6, wherein the doorway is located at the rear end of the dispenser.

9. The ordnance, as claimed in claims 5 or 6, wherein the doorway is located at the front end of the dispenser.

10. The ordnance, as claimed in claims 8 or 9, wherein the detonator is a Thyractron.

11. A method for extinguishing a forest fire which is comprised of the steps of:
(1) carrying and delivering a plurality of submunitions to a doorway on a dispenser;
(2) dispensing a plurality of submunitions from the doorway on the dispenser, each submunition carrying a detonation device, a sensor which communicates with the detonation device, and a volume of retardant;
(3) sending a signal to the detonation device to detonate the submunition based on the spatial positioning data received by the sensor thereby dispersing a volume of fire retardant over the target zone; and
(4) detonating the submunition using a detonation device which receives the signal from the senor, and triggers the detonation device to detonate the explosive upon receipt of this signal.

12. The method as disclosed in claim 11, wherein the step of sending a signal to the detonation device is further comprised of an intermediary step of sending a signal to a Safety and Arm (S&A) device wherein the sensor sends a signal to the S&A device, the S&A device interprets the signal and determines whether to send an arming signal to the detonation device.

13. The method as disclosed in claim 12, wherein the detonation device is a Thyractron.

14. The method as disclosed in claim 13, wherein the sensor is a photo-electric sensor.

15. The method as disclosed in claim 14, wherein the photo-electric sensor receives spatial positioning data for the submunition relative to a reference position and sends an arming signal to the Safety and Arm device based on this data.

16. The method as disclosed in claim 11 or 15, wherein the dispenser is a dropper dispenser.

17. The method as disclosed in claim 11 or 15, wherein the dispenser is an attached dispenser.

18. The method as disclosed in claim 16 or 17, wherein the doorway is opened by an actuation device on the submunition which opens the doorway.

19. The method as claimed in claim 11 or 18, wherein the actuation device is triggered to open the doorway based on data received from a sensor on the submunition, the sensor sending a signal to the actuation device to open the doorway based on this signal.

20. A submunition carried by a dispenser, a missle, a rocket, or a projectile for extinguishing a forest fire by delivering a volume of fire retardant to a target zone, which submunition is comprised of:
an outer housing comprising a first containment portion for containing a volume of fire retardant, a second containment portion for containing an explosive, and a third containment portion for holding a sensor and a detonation device, which sensor communicates with the detonation device for detonating the explosive;
an explosive which is contained in the second containment portion, which explosive is capable of detonation and rupturing the outer wall of the submunition based on a detonation signal received by the detonation device;
a sensor device which receives spatial positioning data based on the position of the submunition in the atmosphere, which sensor interprets the data and is capable of sending a signal to a detonation device to detonate the explosive based on this data;
a detonation device comprising a fuse which communicates with the sensor and sends a detonation signal to trigger the explosive to detonate based on the signal received from the sensor;
wherein the sensor sends an arming signal to the detonation device to detonate the explosive based on spatial positioning data, the arming signal triggering the detonator to detonate the explosive based on receipt of the arming signal thereby rupturing the outer housing of the first containment vessel and releasing a volume of fire retardant over the target zone.

21. The submunition, as claimed in claim 20, wherein the detonation device, is further comprised of a Safety and Arm device.

22. The submunition, as claimed in claim 21, wherein the sensor is a photo-electric sensor.

23. The submunition, as claimed in claim 22, wherein the detonation device is a Thyractron.

24. The submunition, as claimed in claim 23, wherein the photo-electric sensor receives spatial positioning data for the altitude of the submunition relative to ground zero and sends the arming signal to the Safety and Arm device based on this data.

25. The submunition, as claimed in claim 25, wherein the Safety and Arm device upon receipt of the arming signal sends a detonation signal to the detonation device to trigger the detonation device to detonate the explosive.

26. The submunition, as claimed in claims 20 or 25, wherein the submunition is further comprised of a stabilizer fin assemblage.

27. The submunition, as claimed in claims 15 or 25 wherein the reference position for the sensor is ground zero.
